(19) United States
(12) Patent Application Publication
(10) Pub. No.: US 2012/0086956 A1
(43) Pub. Date: Apr. 12, 2012

(54) PRINTING APPARATUS AND STORAGE MEDIUM

(75) Inventor: Toyomi Hirao, Kawasaki-shi (JP)

(73) Assignee: CANON KABUSHIKI KAISHA, Tokyo (JP)

(21) Appl. No.: 13/251,951

(22) Filed: Oct. 3, 2011

(30) Foreign Application Priority Data
Oct. 8, 2010 (JP) 2010-228795

(51) Int. Cl. G06K 15/02

(52) U.S. Cl. 358/1.2

(57) ABSTRACT

An apparatus for printing a tint block image including a latent image and a background image on a sheet includes a first receiving unit configured to receive latent printing density of the latent image, a second receiving unit configured to receive background printing density of the background image, a changing unit configured to change the latent printing density and the background printing density according to the type or the size of sheets to be used in printing, and a printing unit configured to print the tint block image on the sheet according to the changed latent printing density and the changed background printing density.

### BACKGROUND OF THE INVENTION

1. Field of the Invention

The present invention relates to a printing apparatus and a storage medium.

2. Description of the Related Art

Conventionally, for the purpose of inhibiting forgery of a form, a receipt, or the like, there is a printing apparatus for printing a tint block image on a sheet. FIG. 11 is a diagram illustrating an example of the tint block image. In the tint block image, there are a latent image and a background image. The latent image refers to an image that cannot be identified on a document on which the latent image is printed but appears in a reproduction copying a printed matter to be seen by human eyes. The background image refers to an image which disappears or is low in density compared with the density of a latent image which is visualized in a reproduction.

FIG. 12 is a diagram illustrating a state of dots in the print region of these two images. As illustrated in FIG. 12, the tint block image is composed of the background image where the dots are scattered and the latent image where the dots are concentrated in the predetermined region.

Generally, a reading unit on a copying machine, has the critical level of input resolution for reading minute dots on a document and an image forming unit has the critical level of output resolution for reproducing minute dots. When the dots of the background image in the tint block image are formed smaller than the critical level of dots reproducible by the copying machine and the dots of the latent image are formed larger than the critical level, on the copy, the dots of the latent image can be reproduced and the small dots of the background image are not reproduced. Using such characteristics, the latent image is visualized on a copy reproducing the tint block image.

FIGS. 12A and 12B are diagrams illustrating visualization of a latent image. FIG. 12A illustrates an image of a document to be copied. FIG. 12B illustrates an image to be printed. As illustrated in FIG. 12B, the latent image where dots are concentrated is visualized in a copy and the background image where dots are scattered is not reproduced in the copy.

When such the tint block image is printed, there is a technique to perform sample printing in which a plurality of tint block images, where a latent image and a background image are generated according to different density setting, is arranged on one sheet and printed (Japanese Patent Application Laid-Open No. 2005-91730). A user views this sample print, selects the tint block image with desired density among a plurality of tint block images printed according to different density setting, and performs actual printing according to a density setting value corresponding to the selected tint block image.

However, in a case of the conventional technique, since it is not considered that the density of the printed tint block image is changed according to the type of sheets, it causes following problems. For example, when the user views a sample print to determine the density, if the type of sheets to be used in actual printing is a specialty paper such as a coated paper, it is preferable to select the coated paper also as the type of sheets to be used in sample printing. Because even if printed at the same density setting value, depending on the type of sheets, the density of the latent image and the background image to be printed on the sheet is different. Thus, when the user intends to print using the coated paper in actual printing, it is preferable to select the coated paper and perform printing even in sample printing, and input the density setting value corresponding to the desired tint block image among tint block images printed on the coated paper.

However, generally, a specialty paper is expensive. Thus, the user may select an inexpensive plain paper in sample printing to print the tint block image. Then, only when performing actual printing, the user may select the specialty paper to print the tint block image. In this case, the density of the actually printed tint block image is different from the density of the tint block image printed in the sample printing.

### SUMMARY OF THE INVENTION

According to an aspect of the present invention, an apparatus for printing a tint block image including a latent image and a background image on a sheet includes a first receiving unit configured to receive latent printing density of the latent image, a second receiving unit configured to receive background printing density of the background image, a changing unit configured to change the latent printing density and the background printing density according to a type or a size of sheets to be used in printing, and a printing unit configured to print the tint block image on the sheet according to the changed latent printing density and the changed background printing density.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating the configuration of an image processing apparatus according to the present exemplary embodiment.

FIG. 2 is a diagram illustrating an adjustment screen for adjusting a tint block image parameter according to the present exemplary embodiment.

FIG. 3 is a diagram illustrating a screen for setting sample print output according to the present exemplary embodiment.

FIG. 4 is a diagram illustrating a screen for setting latent image section density according to the present exemplary embodiment.

FIG. 5 is a diagram illustrating a screen for setting background section density according to the present exemplary embodiment.

FIG. 6 is a diagram illustrating an example of a sample print according to the present exemplary embodiment.

FIG. 7 is a diagram illustrating a relationship between the setting value of background section density and read density according to the present exemplary embodiment.

FIG. 8 is a diagram illustrating a relationship between the setting value of latent image section density and read density according to the present exemplary embodiment.

FIG. 9 is a flowchart illustrating processing according to the present exemplary embodiment.

FIG. 10 is a flowchart illustrating processing according to the present exemplary embodiment.

FIG. 11 is a diagram illustrating the state of dots in a tint block image.

FIGS. 12A and 12B are diagrams illustrating a state where a tint block image is visualized during copying.

### DESCRIPTION OF THE EMBODIMENTS

Various exemplary embodiments, features, and aspects of the invention will be described in detail below with reference to the drawings.

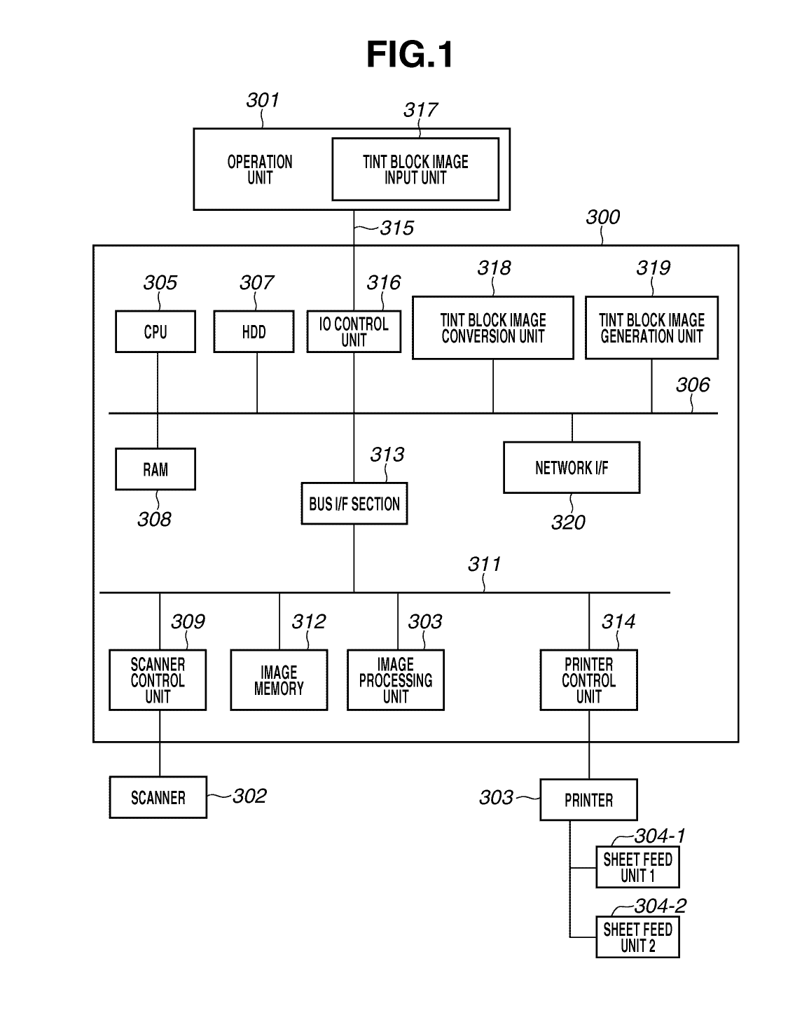

FIG. 1 is a block diagram illustrating the configuration of an image processing apparatus (printing apparatus) according to the present exemplary embodiment. The image processing apparatus is constituted of a controller unit 300, an operation unit 301, a scanner 302, and a printer 303. The controller unit 300 includes a central processing unit (CPU) 305, a data bus 306, a hard disk drive (HDD) 307, a random access memory (RAM) 308, an image processing unit 303, an image memory 312, a bus interface (I/F) 313, a tint block image parameter conversion unit 318, a tint block image generation unit 319, and an network I/F 320.

The CPU 305 is a control unit configured to execute centralized control of the image processing apparatus. The HDD 307 is a storage medium to store image data and programs to be executed by the CPU 305. The RAM 308 is a memory that functions as a work area of the CPU 305. The CPU 305 reads programs stored in the HDD 307 into the RAM 308 via the data bus 306 and executes them. Thus, the CPU 305 executes various types of control of the image processing apparatus. Further, the CPU 305 communicates with an external device such as a personal computer (PC) through the network I/F 320 and via a network.

The operation unit 301 is constituted of a touch panel liquid crystal display (LCD) and a hard key. The operation unit 301 displays an operation screen and receives instructions from a user via the displayed operation screen or the hard key. Further, the operation unit 301 displays the screen according to commands from the CPU 305 to issue notification to a user. The screen display by the operation unit 301 is executed by the processing to rewrite a frame buffer by the CPU 305. Further, the instructions received via the operation unit 301 are input to the CPU 305 via an input-output (IO) data bus 315 and an IO control unit 316. The CPU 305 suitably executes scanning processing and printing processing in response to the input instructions.

When receiving instructions to perform copying from an operation unit 317, the CPU 305 causes the scanner 302 to read a document, receives the read image of the document via a scanner control unit 309, and transfers it to the image processing unit 303. On the image data, processing such as variable magnification, color space conversion, and compression are performed by the image processing unit 303. Thereafter, the image data is once stored in the image memory 312 via an image data bus 311. Then, the CPU 305 reads image data in the image memory 312 to store the read image data in the HDD 307 via the image data bus 311, the bus I/F section 313, and the data bus 306.

After that, when executing printing, the CPU 305 reads image data stored in the HDD307 to transfer it to the image memory 312 via the data bus 306, the bus I/F section 313, and the image data bus 311. On the image data read from the image memory 312, processing such as decoding, rotation, variable magnification, adjustment of printing density, and halftone processing is performed in the image processing unit 313. Then, the image data is output to the printer 303 via a printer control unit 314.

The printer 303 feeds sheets from a sheet feed unit 304-1 or a sheet feed unit 304-2 to print an image on the fed sheet according to the received image data. When executing printing, the CPU 305 notifies the printer 303 of the size and the type (media type) of sheets specified by the user and set on the sheet feed unit. The notified size and type of sheets are managed in the HDD 307 by the CPU 305. The printer 303 changes process conditions such as a fixing temperature and a conveyance speed according to the notified size and type of sheets to perform printing. Further, in the present exemplary embodiment, two sheet feed units are used. However, it is possible to use many sheet feed units.

When performing tint block image printing using such the image processing apparatus, the user inputs parameters (color of tint block image, density of latent image which will be describe bellow, and density of background image) that adjust the tint block image printing, via the tint block image parameter input unit 317 provided on the operation unit 301. The tint block image parameter input unit 317 receives, for example, input of tint block image parameters via a screen provided and displayed as a screen for setting of tint block image printing on the touch panel LCD on the operation unit 301. The tint block image parameters input from the tint block image parameter input unit 317 is delivered to the tint block image generation unit 319 via the IO control unit 316 and the tint block image parameter conversion unit 318. The tint block image generation unit 319 generates the tint block image according to the delivered tint block image parameters to rasterize it on the image memory 312. At this time, the tint block image generation unit 319 forms the tint block image according to only the tint block image parameters obtained via the tint block image parameter conversion unit 318. The tint block image generation unit 319 does not use density adjustment parameters which are used when the image processing unit 303 prints an image (image of document) other than the tint block image.

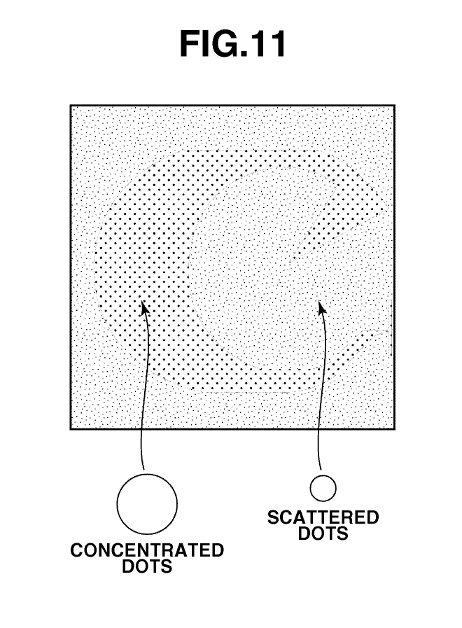

When imparting the tint block image to a printed matter to be copied, the image processing unit 303 reads the document set on the scanner 302. Then, the image processing unit 303 performs halftone processing of yellow (Y), magenta (M), cyan (C), and black (K) ink on the image data of the read document. Then, the image processing unit 303 combines the tint block image rasterized on the image memory 312 with the image data on the document which has been subjected to the halftone processing by the image processing unit 303, to store it in the image memory 312. Then, the CPU 305 transfers the image data stored in the image memory 312 after the combination of the image data, to the printer 303 and causes the printer 303 to print it. Thus, the tint block image can be embedded in a copy of the document image. FIG. 11 is a diagram illustrating the tint block image. The tint block image is used for the purpose of inhibiting forgery of a form, a receipt, for example. The tint block image is also referred to as latent image density.

When the tint block image is embedded in the image of the document and printed, the image processing apparatus uses setting values set beforehand as the tint block image parameters. The tint block image parameters include color of a tint block image, the density of a latent image (also referred to as latent image density), the density of a background image (also referred to as background density), a relative contrast, and the like. The latent image and the background image are images that are contained in the tint block image. The latent image refers to an image that cannot be identified on a printed matter on which the latent image is printed but appears and can be seen by human eyes in a copy reproducing the printed matter. The background image refers to an image which is low in density compared with the density of a latent image that disappears by copying or is visualized in a copy.

The user prints the tint block image using a sample printing function, sees the printed matter with eyes, and confirms it. Then, when the user feels that the background density or the latent image density in the tint block image is too thick or too thin, the user operates the operation unit 301 to change the tint block image parameters. Thus the user can adjust the background density or the latent image density in the tint block image.

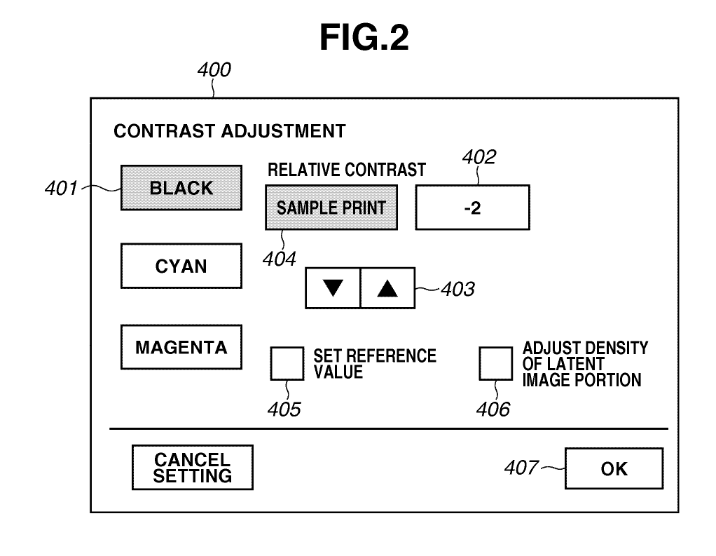

Referring to FIG. 2, adjustment of the background density or the latent image density in the tint block image will be described in detail. An adjustment screen 400 is an example of a tint block image parameter input unit which is displayed on the LCD touch panel on the operation unit 301. A tint block image color setting key 401 sets color of the tint block image. In the present exemplary embodiment, black, cyan, and magenta ink can be selected. The key selected by the user is highlighted so that the color of the tint block image to be selected can visually be determined. A contrast display column 42 is a field where the relative contrast value of a latent image and a background image is displayed. A contrast adjustment key 403 changes the relative contrast value. A reference value setting key 405 displays a screen to adjust background density. A latent image section density key 406 displays a screen to adjust latent image density. An OK key 407 fixes tint block image parameters set in FIGS. 2 to 5. When the OK key 407 is pressed by the user, the CPU 305 stores the set tint block image parameter in the RAM 308. Then, when a start key on the operation unit 317 is pressed to give printing instructions, the CPU 305 reads the image of the document set on the scanner 302, combines the tint block image generated according to the tint block image parameters with the image of the document to print the document.

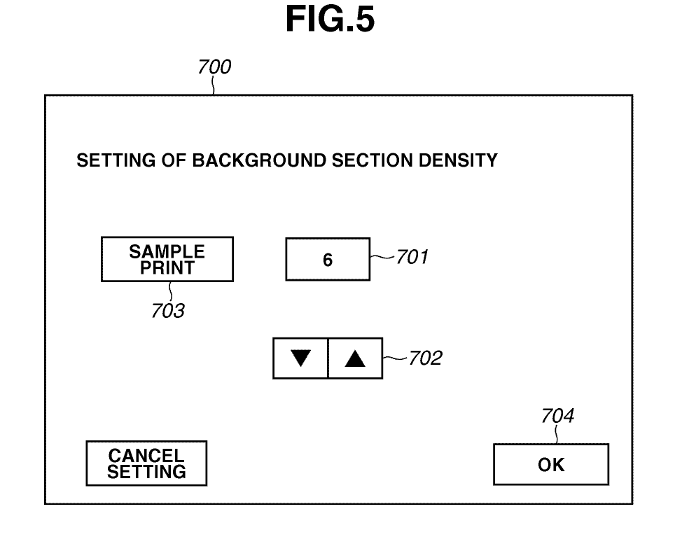

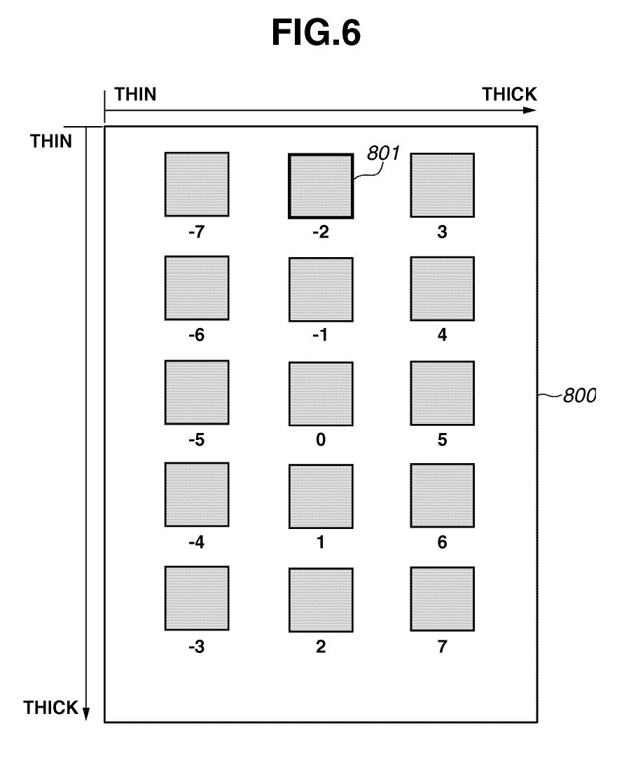

A sample print output key 404 performs sample printing. A sample print is a printed matter as illustrated in FIG. 6. When the sample print output key 404 is pressed, a sample print output screen 500 illustrated in FIG. 5 is displayed. On the sample print output screen 500, a sheet feed unit button 501-1 and a sheet feed unit button 501-2 corresponding to the sheet feed unit 304-1 and the sheet feed unit 304-2 provided on the image processing apparatus are displayed.

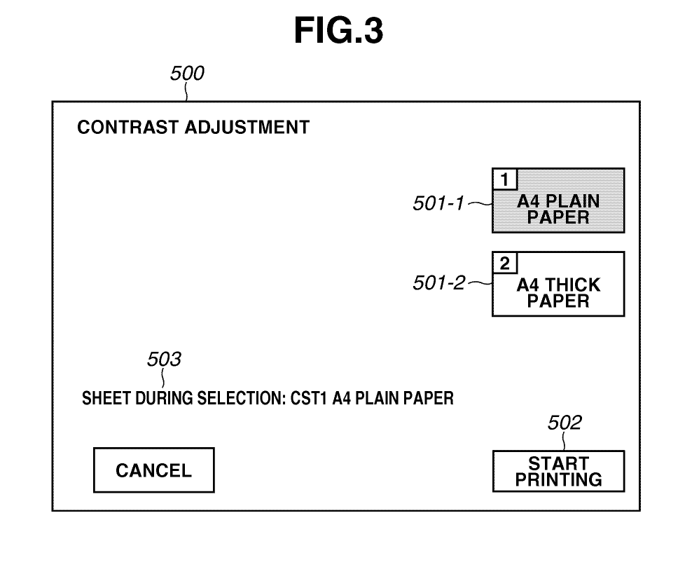

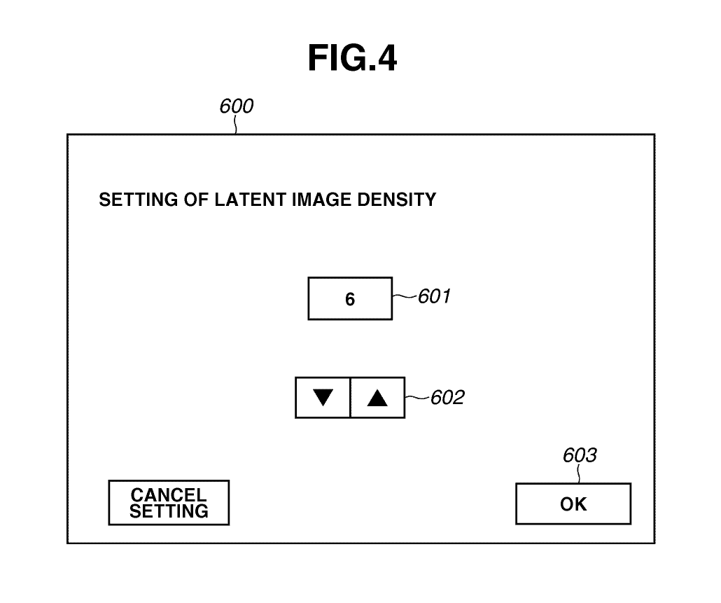

When a printing start key 502 is pressed by the user after the sheet feed unit button 501-1 or the sheet feed unit button 501-2 is selected, the CPU 305 feeds sheets set on the selected sheet feed unit to execute sample print output. A sheet information display column 503 is a field where information concerning the sheet feed unit selected by the user in the feed unit button 501-1 and the sheet feed unit button 501-2 is displayed. In FIG. 3, CST1 (correspond to sheet feed unit 304-1), a size (A4), and a media type (plain paper) are displayed. The sample print output is performed according to a density value set on a latent image density setting screen in FIG. 4 and a density value set on a background density setting screen in FIG. 5.

A latent image density setting screen 600 in FIG. 4 functions as the latent image density input unit. The latent image density setting screen 600 is displayed when the reference value setting key 405 is pressed. A latent image density display column 601 is a field where the value of the latent image density that is currently set is displayed. When a latent image density adjustment key 602 is pressed, the value of the latent image density fluctuates. When an OK key 603 is pressed, the value of the latent image density set at that point is stored in the HDD 307. When a setting cancel key is pressed, the value of the latent image density set at that point is cancelled. Then, a screen in FIG. 3 is displayed.

A background density setting screen 700 in FIG. 5 is displayed when the latent image section density key 406 is pressed. A background density display column 701 functions as a background density input unit. The background density display column 701 is a field where the value of the background density that is currently set is displayed. A background adjustment key 702 is pressed to vary the value of the background density. When an OK key 704 is pressed, the value of the background density set at that point is stored in the HDD 307. When a setting cancel key is pressed, the value of the background density set at that point is cancelled. Then, a screen in FIG. 3 is displayed. A sample print key 703 displays a screen illustrated in FIG. 3. The screen illustrated in FIG. 3 can be displayed from not only the contrast adjustment screen 400 illustrated in FIG. 2 but also from the background density setting screen 700.

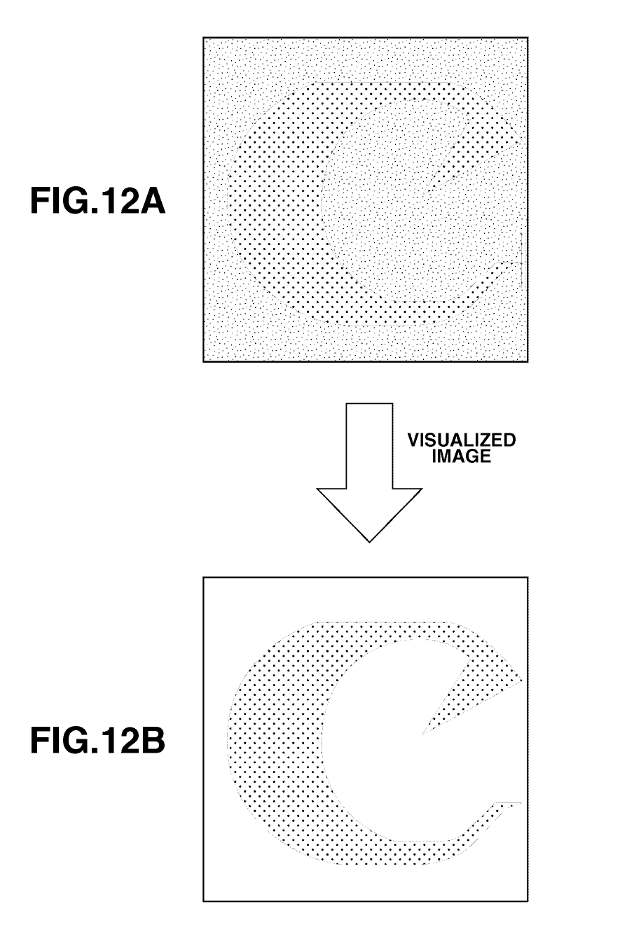

Also when the screen illustrated in FIG. 3 is displayed by the sample print output key 404 or the screen illustrated in FIG. 3 is displayed by the sample print key 703, by pressing the printing start key 502 in FIG. 3, sample printing is performed. An output example of a sample print is illustrated in FIG. 6. A sample print 800 is set on the latent image density setting screen 600. In the sample print 800, a plurality of images is generated while the background density is changed stepwise in the constant latent image density, and the generated image is arranged and printed. Image data which is the base of an image to be printed is prepared in the HDD 307 beforehand. For example, image data in order to print a character image illustrated in FIG. 12 is stored in the HDD 307 beforehand. The character image is printed according to the latent image density and background density differently for each rectangle illustrated in FIG. 6.

At the center of the sample print 800 (place indicated by 0), a tint block image is placed. The tint block image is generated by the tint block image generation unit 319 using the value of the latent image density set by the screen in FIG. 4 and the value of the background image density set by the screen in FIG. 5 as it is. Around the above image, each tint block image is placed in which the background density is changed from +7 to −7 without changing the latent image density. Further, below each tint block image, the adjustment value (+7 to −7) of the background density used in printing of the tint block image is recorded. Among a plurality of tint block images, the tint block image printed according to the latent image density and background density that are currently set by the user is trimmed. Thus, the user can easily see and determine density of the printed tint block image when the tint block image is printed at the current setting.

The user confirms the tint block images based on the different background density printed on this sample print 800 to determine a desired tint block image among a plurality of tint block images. Then, the user operates the contrast adjustment key 403 to input the adjustment value of the background density corresponding to the determined tint block image on the contrast display column 402 illustrated in FIG. 2 as a relative contrast value. For example, when the user intends to adopt the density of the tint block image arranged at the lower left of the sample print 800 and indicated by −3, the user inputs −3 on the contrast display column 402. In this way, the user varies the relative contrast value based on how the background image and the latent image look while confirming a plurality of tint block images printed on the sample print 800. Thus, the user can perform adjustment of the tint block image.

By the operation described above, the background density and the latent image density arbitrarily determined by the user are delivered from tint block image parameter input unit 317 to the tint block image parameter conversion unit 318 via the IO control unit 316 and the IO data bus 315. In the tint block image parameter conversion unit 318, the tint block image is printed according to the delivered background density and latent image density. In this way, the user sets and adjusts the tint block image parameters such as background density and latent image density. Thus, the user can obtain a printed matter on which the intended tint block image is printed in actual printing.

When the user sees the sample print 800 to determine density, if the type of sheets to be used in actual printing is coated paper, it is preferable to select a coated paper also as the type of sheets to be used in sample print output. Specifically, it is preferable to set a coated paper on the sheet feed unit 304-1 and perform sample print output with the sheet feed unit button 501-1 selected in the screen illustrated in FIG. 3. That is because, even if the tint block image is printed in the same density setting value, according to the type of sheets, density of the latent image and background image to be printed on sheets (i.e., how the images look) is different. The reason for that will be described.

Compared with a plain paper and a recycled paper, toner on a coated paper and a thick paper are hard to be fixed. Thus, the image processing apparatus reduces a process speed of a printer when printing a tint block image on a coated paper or a thick paper, compared with a process speed of the printer 303 when printing a tint block image on a plain paper. Therefore, the image processing apparatus spends more time to fix toners on a sheet. The process speed refers to a sheet conveyance speed, a rotation speed of a fixing roller or a pressure roller included in a fixing unit, a rotation speed of a photosensitive drum, and the like. These speeds need to be reduced to fit a decrease in the sheet conveyance speed. When the process speed is reduced, the rotation speed of the photosensitive drum is reduced and hence the amount of exposure per unit time of the photosensitive drum is increased. Thus, the amount of toner per unit area, which is transferred from a development unit to a photosensitive drum is increased. As a result of this, when the toner transferred to the photosensitive drum is transferred on the sheet, the amount of toner per unit area of the sheet is increased and hence the density of the tint block image to be printed on the sheet thickens.

Accordingly, when the user intends to perform actual printing by using a coated paper, it is preferable to select a coated paper even in sample printing and input a density setting value corresponding to the desired tint block image among tint block images printed on the coated paper.

However, generally a specialty paper such as a coated paper is expensive. Thus, the user may select an inexpensive plain paper in sample print output in printing a tint block image. Then, the user may select a specialty paper in actual printing to print a tint block image. Then, the user confirms the tint block image printed on the sample print 800 to determine the density of the latent image and the background image. Thereafter, when the user, instead of the sample print 800, performs actual printing, if a coated paper is specified, the density of the latent image and the background image printed on the coated paper becomes thicker than that of the image printed on the sample print 800. More specifically, the actually printed density of the tint block image is different from the density of the tint block image printed in sample print output. Thus, the output result intended by the user is not obtained.

Further, even if the tint block image is printed at the same density setting value, according to the size of sheets, the density of the latent image and the background image to be printed on the sheet (i.e., how the images look) may be different. For example, compared with a case where the tint block image is printed on the sheet of an A3-size or smaller size, when it is printed on the A3 plus-sized sheet which is longer than the A3-sized sheet, the process speed needs to be reduced. The reason will be described. The temperature (quantity of heat) of the fixing unit is raised to the temperature required for fixing of toners by supplying power to the fixing unit. However, when the sheet is passed through the fixing unit, heat is absorbed by the sheet. Thus, if time spent in fixing is long, the temperature of the fixing unit is reduced.

When toners are fixed on the sheet of the size equal to or smaller than the A3, the fixing unit can retain temperature required to suitably fix toners on the sheet. However, when toners on the A3 plus-sized sheet, which is longer than the A3-sized sheet in a conveyance direction, is fixed, the quantity of heat absorbed by the sheet is large. Thus, the fixing unit cannot retain temperature to suitably fix toners on the sheet. Actually, according to experiments, it was confirmed that when toners are fixed on the rear end of the A3 plus-sized sheet, the temperature of the fixing unit becomes significantly lower than before fixing is started. If the temperature of the fixing unit is reduced, toners cannot suitably be fixed on the sheet. Thus, the intended printing result is not obtained. In order to prevent this, when toners are fixed on the A3 plus-sized sheet, the sheet conveyance speed is reduced. Further, fixing units increase time to fix toners on the sheet. Even if the sheet conveyance speed is reduced, the fact that toners and sheets absorb a large quantity of heat from the fixing unit is not changed. However, the total quantity of heat which can be supplied from the power source to the fixing unit during the fixing is increased. As a result, the fixing unit can prevent temperature from becoming lower than temperature required to suitably fixing toners on the sheet. For these reasons, in a case of the A3 plus-sized sheet, the sheet conveyance speed (process speed) is changed from the sheet conveyance speed of the size which is equal to the A3-sized sheet or smaller.

In order to reduce a fixing speed of the fixing unit, it is required to reduce the sheet conveyance speed. If the sheet conveyance speed is reduced, the rotation speed of the photosensitive drum fitting the sheet conveyance speed also reduces. As a result, time that the photosensitive drum is exposed to light lengthens. Thus, the amount of potential on the photosensitive drum is increased. When the amount of potential on the photosensitive drum is increased, toners are easily put on the photosensitive drum. As a result, the density of toners transferred from the photosensitive drum to the sheet increases. In order to prevent this, the density value of image data generated on the photosensitive drum needs to be corrected.

Thus, in the present image processing apparatus, processing to reduce the density value of image data on a document (what is called Y correction) is applied. This processing is applied in a state where the image data on the document is a multi-level image. Thus, the density in the printed matter of the image data on the document becomes similar to a sheet of not more than the A3-sized sheet.

However, only with that means, the density in the printed matter of the tint block image data remains high. To solve this, a method to similarly apply Y correction to the density of the tint block image data can be considered. However, if the method is applied, the image quality in the printed matter of the tint block image data is significantly degraded. The reason will briefly be described. If Y correction is similarly applied to the density of the tint block image data, density at a place where the density value is originally 255 shows intermediate density such as 240. At the time of printing, halftone processing is applied to this section where the density value is 240. Thus, the halftone result becomes 1 (indicates a pixel on which toners are put) or 0 (indicates a pixel on which toners are not put). In other words, toners are put or are not put on a pixel where toners are originally intended to be put. Further, if halftone processing such as error diffusion is performed, toners can be put on a pixel (pixel with density 0) where toners are originally intended to be put. As a result, in the region where a large dot is originally intended to be disposed, a medium dot is disposed and in the region where a small dot is originally intended to be disposed, a small dot is disposed. As a consequence, an effect of the tint block image (effect of revealing patterns and character strings when copied) is not achieved. Because of such a problem, it is not preferable to apply Y correction to the tint block image data. Thus, in the present exemplary embodiment, with respect to each of the latent image and the back ground image in the tint block image data, density correction processing different from the document image data is applied to the tint block image data.

Accordingly, in the image processing apparatus according to the present exemplary embodiment, the background density and the latent image density input by the user are not adopted as it is but densities changed according to the type (media type) of sheets are adopted. Specifically, when the sample print 800 is performed using a plain paper and actually print is performed using a specialty paper different from the plain paper, the information processing apparatus performs control such that the density of the tint block image to be actually printed is close to the density (state in view) of the tint block image printed by the sample print 800.

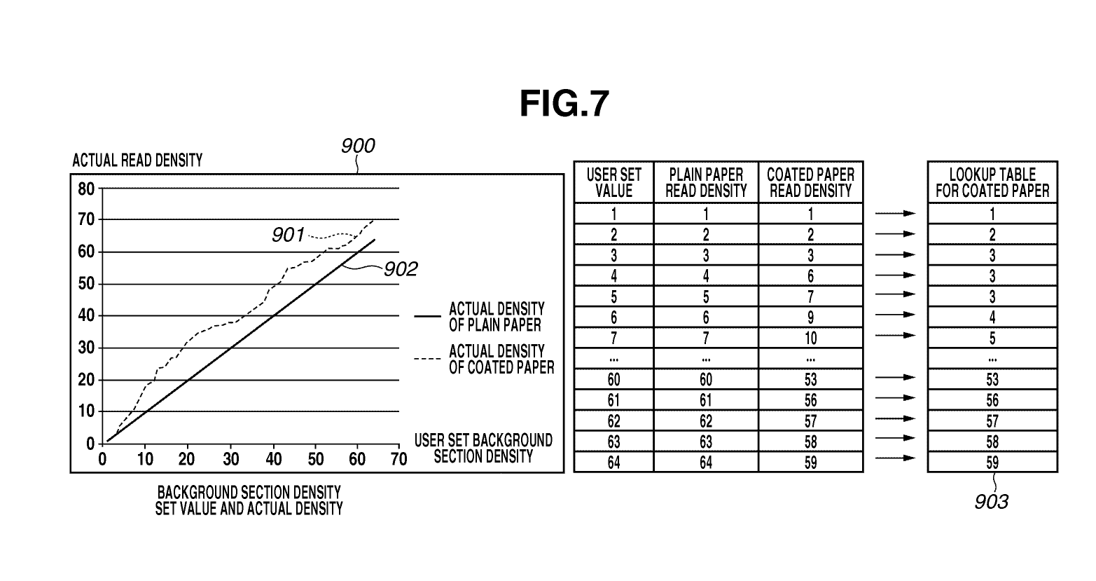

A background density graph 900 in FIG. 7 illustrates a relationship between the setting value of the background density and the actual density. A background density conversion table 903 in FIG. 7 is used to change the background density input by the user. The background density conversion table in FIG. 7 is stored in the HDD 307 beforehand. The background density graph 900 in FIG. 7 expresses the density value of a background image when the background image printed according to the value of the background density to be used by the CPU 305 is read by the scanner 302 in the image processing apparatus. Line 901 is read density of the background image when the tint block image printed on a plain paper is read. Line 902 is read density of the background image when the tint block image printed on a coated paper is read. While in line 902, density is linearly increased, line 901 indicates read density is higher than line 902. Based on the density value expressed in FIG. 7, the background density conversion table 903 for absorbing a difference in density of the background image according to the type of sheets is generated. Specifically, while the setting value of the background density is linearly converted, the printed image is read in order by the scanner 302. The value of the background density of the read image and the value of the background density input by the user are compared. Then, how much density values are to be changed is determined beforehand. In the present exemplary embodiment, an example in which the background density is measured by the scanner 302 in the image processing apparatus is described. However, the background density may also be measured using a colorimeter instead of the scanner 302 in the image processing apparatus.

Then, the tint block image parameter conversion unit 318 changes the value of the background density input by the user referring to the background density conversion table 903 in order to absorb a difference in density of the background image according to the type of this sheet. For example, when the type of sheets to be used in printing is a coated paper, the tint block image parameter conversion unit 318 changes the background density input by the user, using the background density conversion table 903. Specifically, if the type of sheets to be used in printing is coated paper and the value of the background density input by the user is 6, the tint block image parameter conversion unit 318 converts the background density from 6 to 4. However, when the type of sheets to be used in printing is a plain paper, the value of the background density input by the user is used without changing by the tint block image parameter conversion unit 318. Specifically, when the type of sheets to be used in printing is a plain paper and the value of the background density input by the user is 6, 6 is used as the value of the background density.

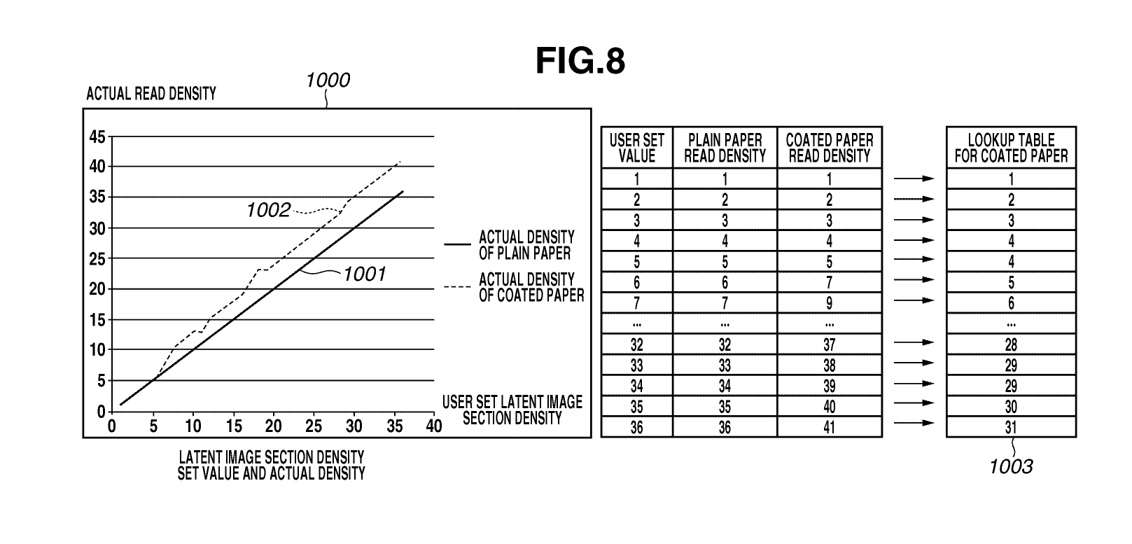

A latent image density graph 1000 in FIG. 8 expresses a relationship between the setting value of latent image density and actual density. A latent image density conversion table in FIG. 8 is used to change the latent image density input by the user. The latent image density conversion table in FIG. 8 is stored in the HDD 307 beforehand. The latent image density graph 1000 in FIG. 8 indicates the density value of a latent image when the latent image printed according to the value of the latent image density to be used by the CPU 305 is read by the scanner 302 in the image processing apparatus. Line 1001 is read density of a latent image when an image printed on a plain paper is read. Line 1002 is read density of a latent image when an image printed on a coated paper is read. While in line 1001, density is linearly increased, line 1002 indicates read density is higher than line 1001. Based on the density value illustrated in FIG. 8, a latent image density conversion table 1003 for absorbing a difference in density of the background image according to the type of sheets is generated. Specifically, while linearly converting the setting value of latent image density, the printed image is read in order by the scanner 302. Then, the value of the latent image density of the read image and the value of the latent image density input by the user are compared. Thus, how much density value is to be changed is determined beforehand. In the present exemplary embodiment, as an example, the latent image density is measured by the scanner 302 in the image processing apparatus. However, the latent image density may be measured using a colorimeter instead of the scanner 302 in the image processing apparatus. Then, the tint block image parameter conversion unit 318 changes the value of the latent image density input by the user referring to the latent image density conversion table 1003 in order to absorb a difference in density of the latent image according to the type of this sheets.

For example, when the type of sheets to be used in printing is a coated paper, the tint block image parameter conversion unit 318 changes the latent image density input by the user, using the latent image density conversion table 1003. Specifically, when the type of sheets to be used in printing is a coated paper and the value of the latent image density input by the user is 6, the tint block image parameter conversion unit 318 converts the background density from 6 to 5. However, when the type of sheets to be used in printing is a plain paper, the value of the latent image density input by the user is used without changing. Specifically, when the type of sheets to be used in printing is a plain paper and the value of the latent image density input by the user is 6, 6 is used as the value of the latent image density.

If a change in density according to the type of sheets can be approximated by a particular mathematical expression, setting values may also be changed by a mathematical model In the present exemplary embodiment, further details of this method is not described. Furthermore, when the read density is dynamically changed by conditions such as temperature in the image forming process, change may be performed by including dynamic offset.

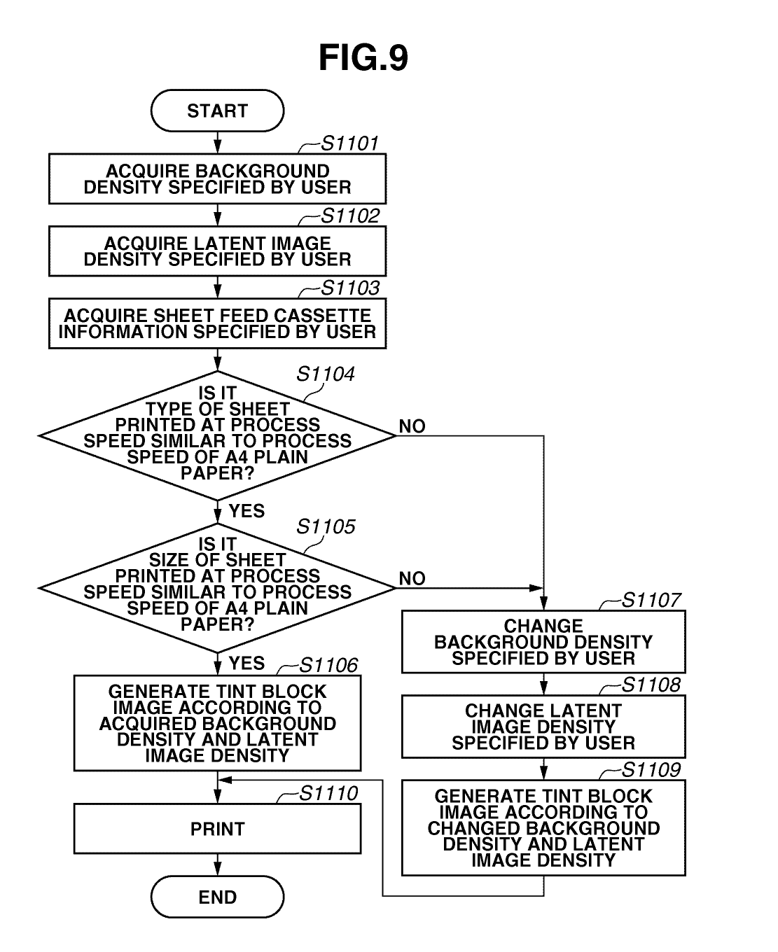

Next, sample print output according to the present exemplary embodiment will be described referring to a flowchart in FIG. 9. The CPU 305 reads a program stored in the HDD 307 into the RAM 308 to execute it to perform each step illustrated in the flowchart in FIG. 9.

When execution of sample printing of a tint block image is instructed via the tint block image parameter input unit 317 in the operation unit 301, each processing illustrated in the flowchart in FIG. 9 is executed. First, in step S1101, the CPU 305 acquires the value of background density specified by a user via the tint block image parameter input unit 317. Next, in step S1102, the CPU 305 acquires the value of latent image density specified by the user via the tint block image parameter input unit 317. The CPU 305 stores the acquired value in the RAM 308.

Next, in step S1103, the CPU 305 acquires information about a sheet feed cassette specified by the user from print setting (copy setting) received via the operation unit 301. For, example, the CPU 305 acquires information about the specified sheet feed cassette via a screen in FIG. 3 to recognize the type, the size, or the like of sheets set on the sheet feed cassette. The CPU 305 stores acquired information about the sheet feed cassette in the RAM 308.

In step S1104, the CPU 305 determines whether the type of sheets specified for printing is the type of sheets which is printed at the same process speed as the process speed of an A4-sized plain paper. For example, if the type of sheets specified for printing is a plain paper, a recycled paper, or a thin paper, the processing proceeds to step S1105. If the type is a coated paper or a thick paper, the processing proceeds to step S1107.

In step S1105, the CPU 305 determines whether the size of sheets specified for printing is the size of sheets which are printed at the same process speed as the process speed of an A4-sized plain paper. For example, if the size of sheets specified for printing is A4, A3, B4, or B5-sized sheet, the processing proceeds to step S1106. If the size is an A3 plus-sized sheet, the processing proceeds to step S1107.

In step S1106, the CPU 305 instructs the tint block image generation unit 319 to generate a background image for the sample print 800 according to background density acquired in step S1101 and generate a latent image according to latent image density acquired in step S1102. The background image and the latent image are generated using an image prepared for sample print output. Then, the CPU 305 stores the generated background image and latent image in the image memory 212. The CPU 305 places a tint block image corresponding to the background density and the latent image density set by the user at the center (place to be indicated by 0) of the sample print 800 and a tint block image in which the background image is changed from −7 to +7 is placed as described referring to FIG. 6. Then, in step S1110, the CPU 305 transfers image data stored in the image memory 212 to the printer 303 and causes the printer 303 to execute printing.

If the processing proceeds to step S1107, the CPU 305 instructs the tint block image parameter conversion unit 318 to change the value of the background density specified by the user according to the background density conversion table corresponding to the type of sheets recognized in step S1103. Further, in step S1108, the CPU 305 instructs the tint block image parameter conversion unit 318 to change the value of the latent image density specified by the user according to the latent image density conversion table corresponding to the type of sheets to be used in printing. If the type of sheets recognized in step S1103 is a coated paper, the CPU 305 changes the value of the background density according to the background density conversion table 903 and the value of the latent image density according to the latent image density conversion table 1003.

In step S1109, the CPU 305 instructs the tint block image generation unit 319 to generate a background image according to the value of the background density changed in step S1107 and a latent image according to the value of the latent image density changed in step S1108. The background image and the latent image are generated using an image prepared for sample print output. Then, the CPU 305 stores the generated background image and latent image in the image memory 212. The CPU 305 places a tint block image corresponding to the background density and the latent image density changed in steps S1107 and S1108 at the center (place indicated by 0) of the sample print 800 and places a tint block image in which the background image is changed from −7 to +7 as described in FIG. 6.

Then, in step S1110, the CPU 305 transfers image data stored in the image memory 212 to the printer 303 and causes the printer 303 to execute printing.

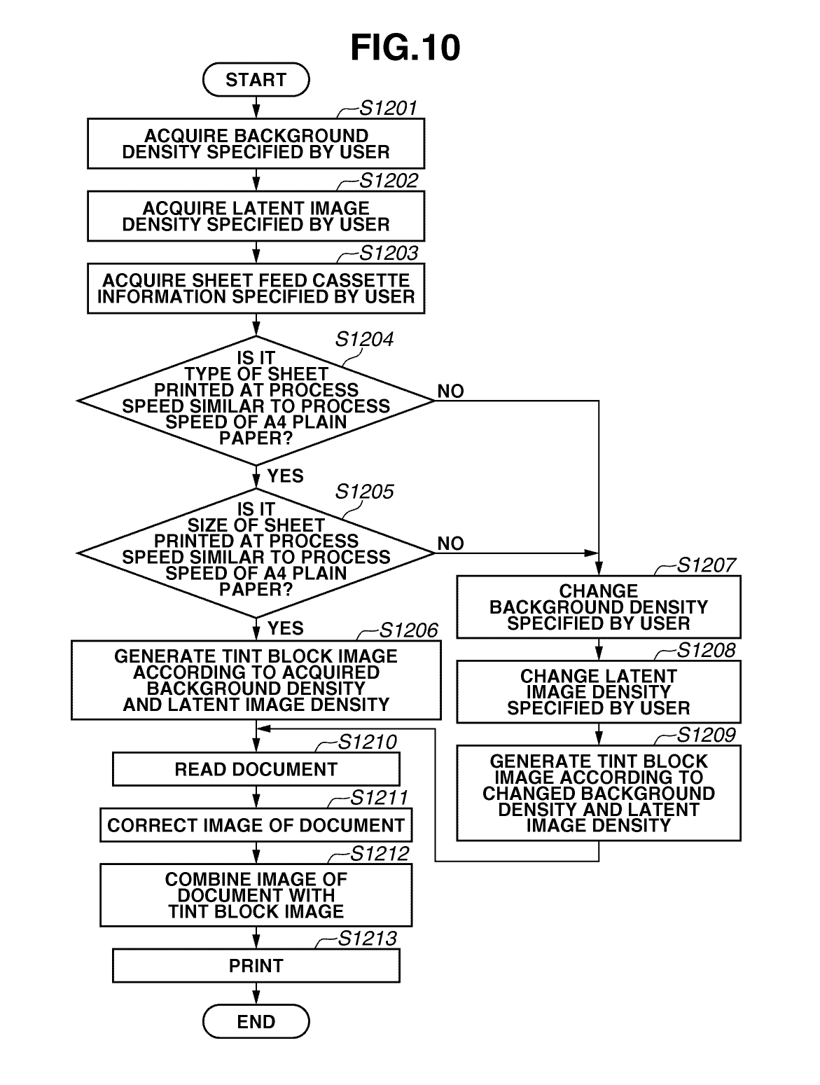

Next, actual printing processing according to the present exemplary embodiment will be described referring to a flowchart in FIG. 10. The CPU 305 reads a program stored in the HDD 307 into the RAM 308 to execute it to perform each step illustrated in the flowchart in FIG. 10. The processing illustrated in this flowchart is started when a start key on the operation unit 301 is pressed.

First, in step S1201, the CPU 305 acquires the value of background density specified by a user via the tint block image parameter input unit 317. Next, in step S 1202, the CPU 305 acquires the value of latent image density specified by the user via the tint block image parameter input unit 317. These values are input using the same screen as when sample printing is performed. The CPU 305 stores the acquired value in the RAM 308.

In step S1203, the CPU 305 acquires information about a sheet feed cassette for actual printing which is specified by the user via the operation unit 301. In specifying the sheet feed cassette, the sheet feed unit 304-1 or the sheet feed unit 304-2 may also directly be specified by the user. Alternatively, the user may select the size and the type of sheets, and the CPU 305 may automatically select the sheet feed unit on which sheets suitable for the size or the type of sheets are set.

In step S1204, the CPU 305 determines whether the type of sheets specified for printing is the type of sheets which is printed at the same process speed as the process speed of an A4-sized plain paper. For example, if the type of sheets specified for printing is a plain paper, a recycled paper, or a thin paper, the processing proceeds to step S1205. If the type is a coated paper or a thick paper, the processing proceeds to step S1207.

In step S1205, the CPU 305 determines whether the size of sheets specified for printing is the size of sheets which is printed at the same process speed as the process speed of an A4-sized plain paper. For example, if the size of sheets specified for printing is A4, A3, B4, or B5-sized sheet, the processing proceeds to step S1206. If the size is an A3 plus-sized sheet, the processing proceeds to step S1207.

In step S1206, the CPU 305 instructs the tint block image generation unit 319 to generate a background image according to the background density acquired in step S1201 and generate a latent image according to the latent image density acquired in step S1202. The background image and the latent image are generated according to image data of a tint block image specified by the user via the operation unit 301 among tint block images stored in the HDD 307 for actual printing.

On the other hand, if the processing proceeds to step S1207, the CPU 305 instructs the tint block image parameter conversion unit 318 to change the value of the background density specified by the user according to the background density conversion table corresponding to the type of sheets recognized in step S1203. Further, in step S1208, the CPU 305 instructs the tint block image parameter conversion unit 318 to change the value of the latent image density specified by the user according to the latent image density conversion table corresponding to the type of sheets to be used in printing. If the type of sheets recognized in step S1203 is a coated paper, the CPU 305 changes the value of the background density according to the background density conversion table 903 and the value of the latent image density according to the latent image density conversion table 1003.

In step S1209, the CPU 305 instructs the tint block image generation unit 319 to generate a background image according to the value of the background density changed in step S1207 and a latent image according to the value of the latent image density changed in step S1208. The background image and the latent image are generated according to image data of a tint block image specified by the user via the operation unit 301 for actual printing.

Then, in step S1210, the CPU 305 instructs the scanner 302 to read an image of a document. In step S1211, the CPU 305 applies Y correction to the image data on the document read in step S1210. In step S1212, the CPU 305 combines the image of the document corrected in step S1211 with the image of the tint block image generated in step S1206 or S1209 to store it in the memory 212. Then, in step S1213, the CPU 305 transfers image data stored in the image memory 212 to the printer 303 and causes the printer 303 to execute printing.

The above-described control reduces a difference between the density of the latent image and the background image to be printed on a specialty paper such as a coated paper, and the density of the latent image and the background image printed in sample printing. In other words, according to when the tint block image is printed on the sheet, a difference between the density of the latent image and the density of the background image, which is caused by a difference in the process speed, is resolved. Thus, also in a case where the different type of sheets is selected between the sample printing and the printing of an actual tint block image, in printing the actual tint block image, the intended printed matter can be obtained.

Further, in the above-described exemplary embodiment, as an example, the background density conversion table and the latent image density conversion table of a coated paper are prepared. However, the present invention is not limited to the coated paper. Similar control can be performed also in a case of other specialty paper which is printed at a process speed different from a plain paper. In this case, a conversion table may be prepared. The conversion table identifies a difference in density of a latent image and a background image between a tint block image printed on a plain paper according to the value set by a user and a tint block image printed on a specialty paper according to the value set by a user, to correct the difference.

Further, in the above-described exemplary embodiment, a method has been described which fills a difference in density when a tint block image is printed on the type or the size of sheets that causes a process speed to change. However, the present invention is not limited to this. For example, a conversion table may also be prepared between the types of sheets which are printed at the same process speed but generate a different look of the printed tint block image. With the conversion table, correction is performed such that the printed tint block image looks the same. Specifically, a conversion table used for a color sheet may be prepared to change the value of density input by a user such that a tint block image printed on the color sheet looks the same as when a tint block image is printed on a reference white plain paper.

Furthermore, in the above-described exemplary embodiment, in printing the sample print 800, data different from the tint block image to be used in actual printing, which is prepared beforehand is used. However, a tint block image which is used in actual printing may also be selected to print the sample print 800. More specifically, a user may also select data of a tint block image, which is used to print the sample print 800, from the HDD 307 to print the sample print 800 using the selected tint block image. Thus, the user can select an image closer to the tint block image which is actually printed.

Still furthermore, in the present exemplary embodiment, the image of the document read by the scanner 302 is combined with the tint block image generated by the tint block image generation unit 319 to print it by the printer 303. However, the present invention is not limited to this. For example, the present invention may also be applied to a case where an image received from an external device by the network I/F 320 is combined with the tint block image generated by the tint block image generation unit 319 to print it by the printer 303. Furthermore, the present invention may also be applied to a case where an image received by a fax receiving unit (not illustrated) is combined with the tint block image generated by the tint block image generation unit 319 to print it by the printer 303.

In the present exemplary embodiment, conversion is performed by the processing using firmware executed by the CPU. However, the present invention is not limited to the control using firmware. Further, in the present exemplary embodiment, conversion of parameters is performed based on a media type. However, the present invention is not limited to the switching operation of the media type. For example, the switching can also be performed according to conditions such as atmospheric temperature and humidity that affect the image forming process or sheet color to be used.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-228795 filed Oct. 8, 2010, which is hereby incorporated by reference herein in its entirety.

What is claimed is:

1. An apparatus for printing a tint block image including a latent image and a background image on a sheet comprising:
a first receiving unit configured to receive latent printing density of the latent image;
a second receiving unit configured to receive background printing density of the background image;
a changing unit configured to change the latent printing density and the background printing density according to one of a type of sheets and a size of sheets to be used in printing; and
a printing unit configured to print the tint block image on the sheet according to the changed latent printing density and the changed background printing density.

2. The apparatus according to claim 1, wherein the changing unit changes the latent printing density and the background printing density according to a size of sheets to be used in the printing.

3. The apparatus according to claim 1, wherein the printing unit performs sample printing to allow a user to confirm an image to be printed, and
wherein the changing unit changes the latent printing density and the background printing density according to the type of sheets to be used in the sample printing.

4. The apparatus according to claim 1, further comprising a storing unit configured to separately store a latent conversion table for the latent printing density and a background conversion table for the background printing density,
wherein the changing unit changes the latent printing density and the background printing density according to the stored latent conversion table and the stored background conversion table, respectively.

5. A method for printing a tint block image including a latent image and a background image on a sheet comprising:
receiving latent printing density of the latent image;
receiving background printing density of the background image;
changing the latent printing density and the background printing density according to one of a size of sheets and a type of sheets to be used in printing; and
printing the tint block image on the sheet according to the changed latent printing density and the changed background printing density.

6. The method according to claim 5, wherein the changing changes the latent printing density and the background printing density according to a size of sheets to be used in the printing.

7. The method according to claim 5, further comprising performing sample printing to allow a user to confirm an image to be printed, and
wherein the changing changes the latent printing density and the background printing density according to the type of sheets to be used in the sample printing.

8. The method according to claim 5, further comprising separately storing a latent conversion table for the latent printing density and a background conversion table for the background printing density,
wherein the changing changes the latent printing density and the background printing density according to the stored latent conversion table and the stored background conversion table, respectively.

9. A computer readable storage medium for storing a computer program for controlling an apparatus for printing a tint block image including a latent image and a background image on a sheet, the computer program comprising:
a code to receive latent printing density of the latent image;
a code to receive background printing density of the background image;
a code to change the latent printing density and the background printing density according to a type of sheets to be used in printing; and
a code to print the tint block image on a sheet according to the changed latent printing density and the changed background printing density.

10. The computer readable storage medium according to claim 9, wherein the changing changes the latent printing density and the background printing density according to a size of sheets to be used in the printing.

11. The computer readable storage medium according to claim 9, further comprising a code to perform sample printing to allow a user to confirm an image to be printed, and
wherein the changing changes the latent printing density and the background printing density according to the type of sheets to be used in the sample printing.

12. The computer readable storage medium according to claim 9, further comprising a code for separately store a latent conversion table for the latent printing density and a background conversion table for the background printing density,
wherein the changing changes the latent printing density and the background printing density according to the stored latent conversion table and the stored background conversion table, respectively.
